(19) United States
(12) Patent Application Publication
(10) Pub. No.: US 2024/0384136 A1
(43) Pub. Date: Nov. 21, 2024

(54) Decorative Film For A Vehicle Interior and Anti-Scatter Film

(71) Applicant: 3M INNOVATIVE PROPERTIES COMPANY, St. Paul, MN (US)

(72) Inventors: Hidetoshi Abe, Yamagata (JP); Ken Okura, Yamagata (JP); Michael Jost, Neuss (DE)

(21) Appl. No.: 18/696,382

(22) PCT Filed: Oct. 10, 2022
(86) PCT No.: PCT/IB2022/059701

§ 371 Date: Mar. 28, 2024

(30) Foreign Application Priority Data
Oct. 15, 2021 (JP) 2021-169623

(51) Int. Cl. C09J 7/30; C09J 7/25; C09J 9/00; C09J 11/04; C09J 11/06

(52) U.S. Cl. CPC C09J 7/30; C09J 7/255; C09J 9/00; C09J 11/04; C09J 11/06; C09J 2301/408; C09J 2433/00; C09J 2467/006

(57) ABSTRACT

A decorative film for a vehicle interior of one embodiment includes a biaxially stretched polyethylene terephthalate film layer and a colored adhesive layer, in which the colored adhesive layer contains a carboxy group-containing (meth)acrylic polymer, an amino group-containing (meth)acrylic polymer, and a colorant, a pencil hardness on a side of the biaxially stretched polyethylene terephthalate film layer of the decorative film is B or greater, a tensile strength at 2% elongation of the decorative film is 50 N/25 mm or more, an elongation of the decorative film is 60% or greater, and a total calorific value for 20 minutes after the start of heating measured in accordance with an ISO 5660-1 cone calorie meter heat resistance test is 8 MJ/m² or less.

The present disclosure relates to a decorative film for a vehicle interior and an anti-scatter film.

A decorative film or sheet in which an adhesive layer is provided on a film substrate is widely used in vehicles such as automobiles, trains, and buses, and the interiors of building. Also, in window glasses of buildings, vehicles, or the like, anti-scatter films have been widely used for the purpose of preventing scattering of glass failure. Some anti-scatter films may have decorative functions.

Patent Document 1 (JP 2003-138235 A) discloses “a tackifier composition having a concealing property, containing 0.1 to 5 parts by weight of aluminum powder having a treated particle surface having an average particle size from 5 to 50 μm and an aspect ratio from 50 to 200 (b) and from 5 to 60 parts by weight of titanium oxide (c) with respect to 100 parts by weight of a resin component of a copolymer containing a (meth)acrylic acid alkyl ester monomer having from 1 to 12 carbon atoms as a main component of an alkyl group (a)” and “a tacky adhesive sheet obtained by applying and drying the tackifier composition having a concealing property on a substrate sheet.

Patent Document 2 (JP 2003-183602 A) discloses “a decorative tacky adhesive sheet obtained by stacking 3 to 50 parts by weight of white pigment with respect to 100 parts by weight of a base polymer of a tackifier and a tackifier containing from 0.3 to 2 wt. % of aluminum metal pieces with respect to the amount of the white pigment added, on one side of a colored film having a total light transmittance from 3 to 80%.

Patent Document 3 (JP 2006-88593 A) discloses “a decorative metallic tacky adhesive sheet obtained by stacking, in the order of, an acrylic resin layer (A) containing an ultraviolet absorber and having a total light transmittance of 85% or greater for visible light, a metallic tackifier layer (B) obtained by containing aluminum metal powder and a pearl pigment in the acrylic tackifier, a colored soft vinyl chloride resin layer (C), and an acrylic tackifier layer (D).

Patent Document 4 (JP 2008-308646 A) discloses “an acrylic colored adhesive containing a carboxyl group-containing (meth)acrylic polymer, a pigment or dye, and an amino group-containing (meth)acrylic polymer that does not contain an aromatic vinyl monomer”, and “a marking film having a base film layer and a tackifier layer formed of the acrylic colored tackifier”.

### SUMMARY

When a decorative film or an anti-scatter film is processed (internally bonded) to an indoor side of a glass substrate, such as a window glass of a building, the film substrate (for example, polyvinyl chloride film), which is a component of these films, may deteriorate or shrink due to exposure to sunlight (particularly exposure to ultraviolet radiation), and a continuous high-temperature environment created by heat stored in a relatively thick glass substrate.

Decorative films used in the interior of vehicles such as trains and buses are required to have durability against external physical forces or influences such as breakage resistance, scratch resistance, graffiti prevention, and puncture resistance.

Examples of the performance required for the anti-scatter film include tensile strength and elongation. For example, according to 6.8 “Tensile strength and elongation test” of JIS A 5759:2016 “Film for construction window glass”, a solar radiation adjusting film and a low radiation film are required to have a tensile strength of 50 N/25 mm or greater and an elongation of 60% or greater, and an impact fracture resistant glass anti-scatter film and an interlayer displacement fracture resistant glass anti-scatter film are required to have a tensile strength of 100 N/25 mm or greater and an elongation of 60% or greater.

Further, when the decorative film and the anti-scatter film are used for a vehicle or a building, it is desirable that the decorative film and the anti-scatter film have a predetermined level of non-flammability.

The present disclosure provides a non-flammable functional adhesive film having excellent durability and mechanical properties, which is used for preventing scattering of a glass substrate such as an interior of a vehicle and a window glass of a building.

The present inventors have found that the above problems can be solved by combining a colored adhesive layer containing a combination of specific (meth)acrylic polymers and a colorant with a biaxially stretched polyethylene terephthalate film as a film substrate.

According to one embodiment, there is provided a decorative film for a vehicle interior including a biaxially stretched polyethylene terephthalate film layer and a colored adhesive layer, in which the colored adhesive layer contains a carboxy group-containing (meth)acrylic polymer, an amino group-containing (meth)acrylic polymer, and a colorant, a pencil hardness on a side of the biaxially stretched polyethylene terephthalate film layer of the decorative film is B or greater, a tensile strength at 2% elongation of the decorative film is 50 N/25 mm or greater, an elongation of the decorative film is 60% or greater, and a total calorific value for 20 minutes after the start of heating measured in accordance with an ISO 5660-1 cone calorie meter heat resistance test is 8 MJ/m² or less.

According to another embodiment, there is provided an anti-scatter film including a biaxially stretched polyethylene terephthalate film layer and a colored adhesive layer, in which the colored adhesive layer contains a carboxy group-containing (meth)acrylic polymer, an amino group-containing (meth)acrylic polymer, and a colorant, a pencil hardness on the biaxially stretched polyethylene terephthalate film layer side of the anti-scatter film is B or more, a tensile strength at 2% elongation of the anti-scatter film is 50 N/25 mm or greater, an elongation of the anti-scatter film is 60% or greater, and a total calorific value for 20 minutes after the start of heating measured in accordance with an ISO 5660-1 cone calorie meter heat resistance test is 8 MJ/m² or less.

According to the present disclosure, there is provided a non-flammable functional adhesive film having excellent durability and mechanical properties, which is used for preventing scattering of a glass substrate such as an interior of a vehicle and a window glass of a building.

The above description will not be construed to mean that all embodiments of the present invention and all advantages of the present invention are disclosed.

### BRIEF DESCRIPTION OF THE DRAWINGS

FIG. 1 is a schematic cross-sectional view of a decorative film (decorative film for a vehicle interior and anti-scatter film) of one embodiment.

FIG. 2 is a graph showing a relationship between an elongation (%, lateral axis) and a tensile strength (N/25 mm, vertical axis) of the decorative film of Example 1 and Comparative Example 1.

### DETAILED DESCRIPTION

Hereinafter, for the purpose of illustrating representative embodiments of the present invention, the present invention will be described in more detail with reference to the drawings, but the present invention is not limited to these embodiments.

In the present disclosure, the term “(meth)acrylic” refers to acrylic or methacrylic, and the term “(meth)acrylate” refers to acrylate or methacrylate.

In the present disclosure, a “film” also encompasses an article referred to as a “sheet”.

In the present disclosure, the term “pressure-sensitive adhesiveness” means the properties of a material or composition that adheres to various surfaces only by application of a slight pressure for a short time in a use temperature range, for example, in a range of 0° C. or higher and 50° C. or lower, and does not exhibit a phase change (from a liquid to a solid). In the present disclosure, “tacky” is used interchangeably with “pressure-sensitive”.

In the present disclosure, the phrase “disposed on” includes not only a case of being disposed directly on, but also a case of being disposed indirectly, that is, via another material or layer.

The decorative film for a vehicle interior and the anti-scatter film according to one embodiment include a biaxially stretched polyethylene terephthalate film layer (hereinafter, also referred to as a “biaxially stretched PET film layer” in the present disclosure), and a colored adhesive layer. Hereinafter, in the present disclosure, the decorative film for a vehicle interior and the anti-scatter film are simply collectively referred to as “decorative film”.

The biaxially stretched PET film layer and the colored adhesive layer may be in direct contact with each other, and other layers such as a colored layer, a printed layer, and a bulk layer may be interposed between these layers. Other layers such as a colored layer, a printed layer, a bulk layer, and a surface protective layer may be disposed on the biaxially stretched PET film layer.

In one embodiment, the decorative film consists of a biaxially stretched PET film layer and a colored adhesive layer. The phrase “consists of a biaxially stretched PET film layer and a colored adhesive layer” means that the decorative film does not include any layer other than the biaxially stretched PET film layer and the colored adhesive layer, and a liner removed during use.

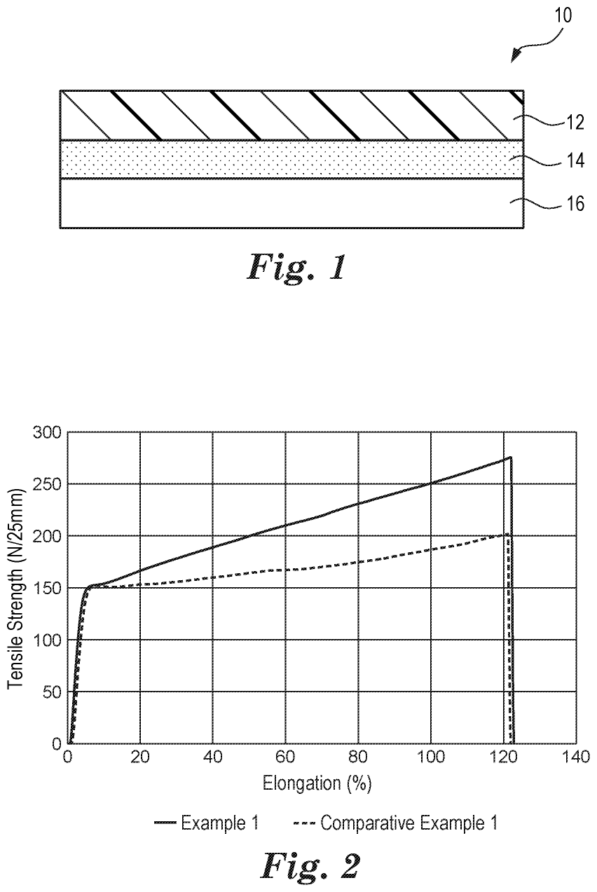

FIG. 1 is a schematic cross-sectional view of a decorative film (film for a vehicle interior and anti-scatter film) of one embodiment. A decorative film 10 includes a biaxially stretched PET film layer 12 and a colored adhesive layer 14. The decorative film 10 of FIG. 1 further includes a liner 16 as an optional component. The liner 16 is removed before the decorative film 10 is attached to an adherend.

The present inventors have found that a biaxially stretched PET film is superior to an acrylic resin film generally used for a decorative film in terms of durability, strength, and non-flammability (oxygen consumption during combustion) to mechanical force from the outside, and as with the acrylic resin film, the biaxially stretched PET film is less thermally shrinkable in a high-temperature environment than a polyvinyl chloride film generally used for a decorative film, and have employed a biaxially stretched PET film as a film substrate of the decorative film of the present disclosure. Due to these properties of the biaxially stretched PET film, even when the thickness of the biaxially stretched PET film is reduced, the durability and the mechanical properties required for use as a decorative film for a vehicle interior or an anti-scatter film can be satisfied, and further, when the thickness is reduced in such a manner, more excellent non-flammability can be obtained.

The biaxially stretched PET film layer may contain only polyethylene terephthalate as a resin component, and may contain polyethylene terephthalate and other resins, for example, polyesters such as polybutylene terephthalate (PBT) and polyethylene naphthalate (PEN), polyolefins such as polycarbonate, polyethylene, and polypropylene, an acrylic resin, polystyrene, polyamide, or polyurethane, or two or more kinds thereof. From the viewpoint of the transparency and the mechanical properties, the biaxially stretched PET film layer preferably contains polyethylene terephthalate as a resin component in an amount of more than 50 mass % as a main component, and more preferably contains only polyethylene terephthalate.

A draw ratio of the biaxially stretched PET film layer may vary depending on the application, for example, MD (Machine Direction: flow direction of resin/TD (Transverse Direction: width direction of resin) can be approximately 0.1 or greater, approximately 0.2 or greater, or approximately 0.5 or greater, approximately 10 or less, approximately 5 or less, or approximately 2 or less.

The thickness of the biaxially stretched PET film layer can vary, and can be, for example, approximately 10 μm or greater, approximately 12 μm or greater, or approximately 15 μm or greater, and approximately 200 μm or less, approximately 150 um or less, or approximately 100 μm or less. From the viewpoint of elongation and non-flammability of the decorative film, the thickness of the biaxially stretched PET film layer is preferably approximately 80 μm or less, and more preferably approximately 50 μm or less.

The biaxially stretched PET film layer is preferably colorless and transparent, or has transparency to such an extent that the color of the colored adhesive layer can be visually recognized through the biaxially stretched PET film layer. In one embodiment, a total light transmittance of the biaxially stretched PET film layer in a wavelength range from 380 to 780 nm is approximately 80% or greater, approximately 85% or greater, or approximately 90% or greater, and 100% or less. In the present disclosure, the total light transmittance is measured in accordance with JIS A 5759:2008.

In one embodiment, the biaxially stretched PET film layer includes an ultraviolet absorber. Examples of the ultraviolet absorber include a benzotriazole compound, a hydroxyphenyltriazine compound, and a cyanoacrylate compound. Specific product names thereof include Tinuvin (trade name) 99-2, Tinuvin (trade name) 928, Tinuvin (trade name) P, Tinuvin (trade name) 479, and Tinuvin (trade name) 1130 (which are all available from BASF Japan Ltd., Chuo-ku, Tokyo, Japan). The content of the ultraviolet absorber can be approximately 0.5 mass % or greater or approximately 1 mass % or greater, and approximately 10 mass % or less or approximately 5 mass % or less, based on the mass of the biaxially stretched PET film layer.

The biaxially stretched PET film layer may contain a hindered amine light stabilizer (HALS) such as Tinuvin (trade name) 292, Tinuvin (trade name) 123, Tinuvin (trade name) 622SF, and Tinuvin (trade name) 770 (which are all available from BASF Japan Ltd., Chuo-ku, Tokyo, Japan) instead of or in addition to the ultraviolet absorber.

The surface of the biaxially stretched PET film layer in contact with the colored adhesive layer may be subjected to a surface treatment such as a primer treatment, a corona treatment, or a plasma treatment. Examples of the primer treatment include a treatment using a primer agent containing a carbodiimide compound, an amine compound, or an epoxy compound.

The biaxially stretched PET film layer may be colored with a colorant such as a pigment and dye. The biaxially stretched PET film layer may include a printed layer including a pattern, a shape, a letter, or the like on a surface thereof. The biaxially stretched PET film layer may include a matte or clear hard coat layer, a hydrophilic coating layer, a hydrophobic coating layer, a transparent over-laminate film layer, or the like on the surface opposite to the colored adhesive layer. The surface of the biaxially stretched PET film layer in contact with these printed layers or the like may be subjected to a surface treatment such as a primer treatment, a corona treatment, or a plasma in treatment.

The colored adhesive layer contains a carboxy group-containing (meth)acrylic polymer, an amino group-containing (meth)acrylic polymer, and a colorant. When the colored adhesive layer contains the carboxy group-containing (meth)acrylic polymer and the amino group-containing (meth)acrylic polymer, the colored adhesive layer can contain the colorant in a state of being uniformly dispersed at a high concentration by utilizing the interaction between the colorant and the carboxy group or the amino group. Therefore, even if the colored adhesive layer is made relatively thin, a decorative film having various chroma and brightness can be provided. It is also advantageous that the colored adhesive layer can be thinned from the viewpoint of the non-flammability.

The carboxy group-containing (meth)acrylic polymer can increase a cohesive force of the colored adhesive layer due to the presence of the carboxy group to improve an adhesive force. The carboxy group-containing (meth)acrylic polymer may enhance adhesion between the biaxially stretched PET film layer and the colored adhesive layer.

The carboxy group-containing (meth)acrylic polymer can be obtained by copolymerizing a polymerizable composition containing a (meth)acrylic monomer, a carboxy group-containing monomer, and if necessary, another monomer having a monoethylenically unsaturated group. In the present disclosure, a (meth)acrylic monomer, a carboxy group-containing monomer, an amino group-containing monomer, and another monomer having a monoethylenically unsaturated group are collectively referred to as a polymerizable component. The (meth)acrylic monomer, the carboxy group-containing monomer, and another monomer having a monoethylenically unsaturated group may be used alone, or two or more thereof may be used in combination.

The (meth)acrylic monomer generally includes alkyl (meth)acrylate. The number of carbon atoms of the alkyl group of the alkyl (meth)acrylate may be 1 to 12. Examples of the alkyl (meth)acrylate include linear or branched alkyl (meth)acrylates such as methyl (meth)acrylate, ethyl (meth)acrylate, n-butyl (meth)acrylate, isobutyl (meth)acrylate, 2-methylbutyl (meth)acrylate, isoamyl (meth)acrylate, n-hexyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and n-dodecyl (meth)acrylate; and alicyclic (meth)acrylates such as cyclohexyl (meth)acrylate, 4-t-butylcyclohexyl (meth)acrylate, and isobornyl (meth)acrylate. The alkyl (meth)acrylate preferably contains methyl (meth)acrylate, n-butyl (meth)acrylate, 2-ethylhexyl acrylate, or a combination thereof.

The alkyl (meth)acrylate constitutes a main component of the carboxy group-containing (meth)acrylic polymer. In one embodiment, the carboxy group-containing (meth)acrylic polymer is obtained by copolymerizing a polymerizable composition containing alkyl (meth)acrylate in an amount of approximately 50 mass % or greater, approximately 70 mass % or greater, or approximately 80 mass % or greater, approximately 99.5 mass % or less, approximately 99 mass % or less, or approximately 98 mass % or less, based on the mass of the polymerizable component, and contains a constituent unit derived from alkyl (meth)acrylate at the above mass ratio.

The (meth)acrylic monomer may contain an aromatic (meth)acrylate such as phenyl (meth)acrylate or p-tolyl (meth)acrylate; phenoxyalkyl (meth)acrylates such as phenoxyethyl (meth)acrylate; alkoxyalkyl (meth)acrylates such as methoxypropyl (meth)acrylate and 2-methoxybutyl (meth)acrylate; or cyclic ether-containing (meth)acrylate such as glycidyl (meth)acrylate or tetrahydrofurfuryl (meth)acrylate.

Examples of the carboxy group-containing monomer include (meth)acrylic acid, monohydroxyethyl phthalate (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid. The carboxy group-containing monomer is preferably (meth)acrylic acid. In the present disclosure, those corresponding to both the (meth)acrylic monomer and the carboxy group-containing monomer, such as (meth)acrylic acid, are treated as carboxy group-containing monomers.

In one embodiment, the carboxy group-containing (meth)acrylic polymer is obtained by copolymerizing a polymerizable composition containing the carboxy group-containing monomer in an amount of approximately 0.5 mass % or greater, approximately 1 mass % or greater, or approximately 2 mass % or greater, approximately 15 mass % or less, approximately 10 mass % or less, or approximately 8 mass % or less, based on the mass of the polymerizable component, and contains a constituent unit derived from the carboxy group-containing monomer at the above mass ratio.

Examples of the (meth)acrylic monomer or another monomer having a monoethylenically unsaturated group include amide group-containing monomers such as (meth)acrylamide, N-vinylpyrrolidone, and N-vinylcaprolactam; hydroxyl group-containing monomers such as 2-hydroxyethyl (meth)acrylate, 2-hydroxypropyl (meth)acrylate, and 4-hydroxybutyl (meth)acrylate; unsaturated nitriles such as (meth)acrylonitrile: aromatic vinyl monomers such as styrene, a-methylstyrene, and vinyltoluene; and vinyl esters such as vinyl acetate.

The copolymerization of the carboxy group-containing (meth)acrylic polymer can be performed by radical polymerization. As the radical polymerization, a known polymerization method such as solution polymerization, suspension polymerization, emulsion polymerization, or bulk polymerization can be used. It is advantageous to use a solution polymerization that allows easy synthesis of high molecular weight polymers. Examples of the polymerization initiator include organic peroxides such as benzoyl peroxide, lauroyl peroxide, and bis(4-tert-butylcyclohexyl) peroxydicarbonate; or azo polymerization initiators such as 2,2′-azobisisobutyronitrile, 2,2′-azobis(2-methylbutyronitrile), dimethyl-2,2-azobis(2-methylpropionate), 4,4′-azobis(4-cyanovaleric acid), 2,2′-azobis(2-methylpropionic acid) dimethyl, and azobis(2,4-dimethylvaleronitrile) (AVN). The amount of the polymerization initiator used is generally approximately 0.01 parts by mass or greater or approximately 0.05 parts by mass or greater, and approximately 5 parts by mass or less or approximately 3 parts by mass or less, based on 100 parts by mass of the polymerizable component.

The amino group-containing (meth)acrylic polymer can enhance the cohesive force of the colored adhesive layer by interaction with the carboxy group-containing (meth)acrylic polymer to improve the adhesive properties of the colored adhesive layer. The amino group-containing (meth)acrylic polymer has an ability to trap a trace amount of metal ions, for example, iron ions, contained in glass serving as an adherend with an amino group. Thus, when the decorative film is applied to the glass substrate, the depolymerization reaction of the (meth)acrylic polymer that can be catalyzed by the metal ion activated by the ultraviolet ray contained in the sunlight under a high-temperature environment can be suppressed, and the adhesive force of the colored adhesive layer can be maintained at a desired level.

The amino group-containing (meth)acrylic polymer can be obtained by copolymerizing a polymerizable composition containing a (meth)acrylic monomer, an amino group-containing monomer, and if necessary, another monomer having a monoethylenically unsaturated group. The (meth)acrylic monomer, the amino group-containing monomer, and another monomer having a monoethylenically unsaturated group may be used alone, or two or more thereof may be used in combination.

As the (meth)acrylic monomer and another monomer having a monoethylenically unsaturated group, the same monomers as those described for the carboxy group-containing (meth)acrylic polymer can be used.

The alkyl (meth)acrylate constitutes a main component of the amino group-containing (meth)acrylic polymer. In one embodiment, the amino group-containing (meth)acrylic polymer is obtained by copolymerizing a polymerizable composition containing alkyl (meth)acrylate in an amount of approximately 50 mass % or greater, approximately 70 mass % or greater, or approximately 80 mass % or greater, approximately 99.5 mass % or less, approximately 99 mass % or less, or approximately 98 mass % or less, based on the mass of the polymerizable component, and contains a constituent unit derived from alkyl (meth)acrylate at the above mass ratio.

Examples of the amino group-containing monomer include aminoalkyl (meth)acrylates such as aminoethyl (meth)acrylate; monoalkylaminoalkyl (meth)acrylates such as butylaminoethyl (meth)acrylate: dialkylaminoalkyl (meth)acrylates such as N,N-dimethylaminoethyl acrylate (DMAEA) and N,N-dimethylaminoethyl methacrylate (DMAEMA); dialkylaminoalkyl (meth)acrylamides such as N,N-dimethylaminopropyl acrylamide (DMAPAA) and N,N-dimethylaminopropyl methacrylamide: and dialkylaminoalkyl vinyl ethers such as N,N-dimethylaminoethyl vinyl ether and N,N-diethylaminoethyl vinyl ether. The amino group-containing monomer is preferably dialkylaminoalkyl (meth)acrylates such as N,N-dimethylaminoethyl acrylate (DMAEA) or N,N-dimethylaminoethyl methacrylate (DMAEMA). In the present disclosure, those corresponding to both the (meth)acrylic monomer and the amino group-containing monomer, such as aminoethyl (meth)acrylate, are treated as the amino group-containing monomer.

In one embodiment, the amino group-containing (meth)acrylic polymer is obtained by copolymerizing a polymerizable composition containing the amino group-containing monomer in an amount of approximately 0.5 mass % or greater, approximately 1 mass % or greater, or approximately 2 mass % or greater, approximately 20 mass % or less, approximately 15 mass % or less, or approximately 10 mass % or less, based on the mass of the polymerizable component, and contains a constituent unit derived from the amino group-containing monomer at the above mass ratio.

The amino group-containing (meth)acrylic polymer is preferably an amino group-containing (meth)acrylic polymer containing no monomer unit derived from an aromatic vinyl monomer (hereinafter, also referred to as an “amino group-containing non-aromatic (meth)acrylic polymer” in the present disclosure). Since the amino group-containing non-aromatic (meth)acrylic polymer is excellent in compatibility with the carboxy group-containing (meth)acrylic polymer, the interaction with the carboxy group-containing (meth)acrylic polymer can be made more effective.

The amino group-containing non-aromatic (meth)acrylic polymer does not contain a constituent unit derived from an aromatic vinyl monomer. Examples of the aromatic vinyl monomer include styrene, α-methylstyrene, vinyltoluene, vinylnaphthalene, vinylanthracene, vinylanthraquinone, (meth)acrylamide of an aromatic amine, and (meth)acrylate of a hydroxyl group-containing aromatic compound. Examples of the aromatic amine include aniline, benzylamine, naphthylamine, aminoanthracene, aminoanthraquinone, and derivatives thereof. Examples of the hydroxyl group-containing aromatic compound include a hydroxyl group-containing compound corresponding to the aromatic amine.

The copolymerization of the amino group-containing (meth)acrylic polymer can also be performed by radical polymerization in the same manner as the copolymerization of the carboxy group-containing (meth)acrylic polymer. The polymerization method, the polymerization initiator, and the use amount thereof are the same as those described for the copolymerization of the carboxy group-containing (meth)acrylic polymer.

In the colored adhesive layer, at least one of the carboxy group-containing (meth)acrylic polymer and the amino group-containing (meth)acrylic polymer functions as an acrylic tacky polymer. The acrylic tacky polymer imparts pressure-sensitive adhesiveness to the colored adhesive layer at a use temperature (for example, 5° C. to 35° C.).

The glass transition temperature (Tg) of the acrylic tacky polymer can be approximately −70° C. to approximately −20° C. In one embodiment, the glass transition temperature of the acrylic tacky polymer is approximately −65° C. or higher or approximately −60° C. or higher, and approximately −25° C. or lower or approximately −30° C. or lower. By setting the glass transition temperature of the acrylic tacky polymer to approximately −70° C. or higher, the adhesive force and the holding force can be imparted to the colored adhesive layer. By setting the glass transition temperature of the acrylic tacky polymer to approximately −20° C. or lower, initial adhesiveness (tack) can be effectively imparted to the colored adhesive layer.

The glass transition temperature (Tg) of the acrylic tacky polymer can be determined as a calculated glass transition temperature from the following formula (Fox, T.G., Bull. Am. Phys. Soc., 1 (1956), p. 123) of FOX based on the assumption that each polymer is copolymerized from n kinds of monomers.

$$\frac{1}{Tg + 27 \; 3.15} = {\sum }_{i = 1}^{n} ( \frac{{X}_{i}}{{Tg}_{í} + 273.15} ) \qquad [ Formula 1 ]$$

wherein Tgᵢ represents a glass transition temperature (° C.) of a homopolymer of a component i, Xᵢ represents a mass fraction of the monomer of the component i added during polymerization, and i is a natural number of 1 to n.

$${\sum }_{i = 1}^{n} {X}_{i} = 1 \qquad [ Formula 2 ]$$

In one embodiment, the weight average molecular weight (Mw) of the acrylic tacky polymer is approximately 150000 or greater, approximately 200000 or greater, or approximately 250000 or greater, and approximately 2000000 or less, approximately 1500000 or less, or approximately 1000000 or less. In the present disclosure, the “weight average molecular weight” means a molecular weight converted in terms of standard polystyrene by a gel permeation chromatography (GPC) method.

The mass ratio of the carboxy group-containing (meth)acrylic polymer to the amino group-containing (meth)acrylic polymer can be 100: approximately from 0.1 to 50,100: approximately from 1 to 40, or 100: approximately from 2 to 30 (when the carboxy group-containing (meth)acrylic polymer functions as an acrylic tacky polymer), or approximately from 0.1 to 50:100, approximately from 1 to 40:100, or approximately from 2 to 30:100 (when the amino group-containing (meth)acrylic polymer functions as an acrylic tacky polymer).

When a general decorative film is applied (internally bonded) to glass substrates such as a window glass of a vehicle or a building, an adhesive contained in an adhesive layer constituting the decorative film may deteriorate. The deterioration of the adhesive is specifically the decomposition of the tacky polymers, for example, acrylic tacky polymers, which are the main components of the adhesive, and it is considered that the main factor is continuous high-temperature environment created by exposure to sunlight (in particular, exposure to ultraviolet rays) passing through the glass substrate and heat accumulated in a relatively thick glass substrate. It is generally known that weather resistance of a decorative film is enhanced by including an ultraviolet absorber in a film substrate of the decorative film. However, in the case of internal bonding, since the film substrate is located on a back surface of the adhesive layer with respect to sunlight, the ultraviolet absorber contained in the film substrate does not directly contribute to reducing the amount of ultraviolet rays incident on the adhesive layer. As described above, the deterioration of the adhesive in the decorative film becomes a problem in the internal bonding rather than the external bonding (the decorative film is applied to the outside of the vehicle or the outdoor side of the glass substrate). When the adhesive is deteriorated, the cohesive force of the adhesive is reduced, and the internal stress of the film substrate generated at the time of application overcomes the cohesive force of the adhesive to shrink the decorative film, or air bubbles may be generated between the decorative film and the glass substrate.

In one embodiment, a (meth)acrylic polymer different from the (meth)acrylic polymer functioning as an acrylic tacky polymer may function as an acrylic polymer additive. That is, when the carboxy group-containing (meth)acrylic polymer functions as an acrylic tacky polymer, the amino group-containing (meth)acrylic polymer may function as an acrylic polymer additive, and when the amino group-containing (meth)acrylic polymer functions as an acrylic tacky polymer, the carboxy group-containing (meth)acrylic polymer may function as an acrylic polymer additive. The acrylic polymer additive can suppress a decrease in cohesive force due to depolymerization of the acrylic tacky polymer caused by exposure to sunlight or the like through an acid (carboxy group)-base (amino group) interaction with the acrylic tacky polymer, and can maintain adhesive force at a desired level.

In one embodiment, the carboxy group-containing (meth)acrylic polymer is an acrylic tacky polymer, and the amino group-containing (meth)acrylic polymer is an acrylic polymer additive.

The glass transition temperature (Tg) of the acrylic polymer additive can be approximately −20° C. to approximately −120° C. In one embodiment, the glass transition temperature of the acrylic polymer additive is approximately 30° C. or higher or approximately 45° C. or higher, and approximately 100° C. or lower or approximately −80° C. or lower. By setting the glass transition temperature of the acrylic polymer additive to approximately 20° C. or higher, it is possible to suppress a decrease in cohesive force due to depolymerization of the acrylic tacky polymer caused by exposure to sunlight or the like, and to maintain the adhesive force at a desired level. By setting the glass transition temperature of the acrylic polymer additive to approximately 100° C. or lower, the adhesiveness in a normal temperature range can be secured. The glass transition temperature of the acrylic polymer additive can be determined using the formula FOX as well as the acrylic tacky polymer.

In one embodiment, the weight average molecular weight (Mw) of the acrylic polymer additive is approximately 1000 or greater, approximately 5000 or greater, or approximately 10000 or greater, and approximately 200000 or less, approximately 100000or less, or approximately 80000 or less.

In one embodiment, the glass transition temperature of the carboxy group-containing (meth)acrylic polymer or the amino group-containing (meth)acrylic polymer functioning as an acrylic tacky polymer is approximately −70° C. to approximately −20° C., the glass transition temperature of the carboxy group-containing (meth)acrylic polymer or the amino group-containing (meth)acrylic polymer functioning as the acrylic polymer additive is 20° C. to 120° C., and the content of the acrylic polymer additive in the colored adhesive layer is approximately 11 parts by mass to approximately 40 parts by mass based on 100 parts by mass of the acrylic tacky polymer. The content of the acrylic polymer additive is preferably approximately 12 parts by mass or greater, or approximately 15 parts by mass or greater, preferably approximately 30 parts by mass or less, or approximately 25 parts by mass, based on 100 parts by mass of the acrylic tacky polymer. When the content of the acrylic polymer additive is approximately 11 parts by mass or greater based on 100 parts by mass of the acrylic tacky polymer, the acrylic polymer additive having a high glass transition temperature of 20° C. to 120° C. can suppress a decrease in the cohesive force of the acrylic tacky polymer caused by exposure to sunlight, and can maintain the adhesive force of the colored adhesive layer at a desired level. By setting the content of the acrylic polymer additive to approximately 40 parts by mass or less based on 100 parts by mass of the acrylic tacky polymer, the adhesiveness can be secured even at a low temperature

Examples of the colorant include pigments and dyes. The pigments and dyes can be used singly or in combination of two or more kinds thereof. The form of the pigment and the dye is not particularly limited, and may be subjected to a dispersion treatment.

Examples of the pigments include inorganic pigments such as zinc carbonate, zinc oxide, zinc sulfide, talc, kaolin, calcium carbonate, titanium oxide, carbon black, yellow lead, yellow iron oxide, bengala, red iron oxide, barium sulfate, alumina, zirconia, an iron oxide pigment, an iron hydroxide pigment, a chromium oxide pigment, a spinel-type fired pigment, a chromic acid pigment, a chromium vermilion pigment, a Prussian blue pigment, an aluminum powder pigment, a bronze powder pigment, and calcium phosphate; and organic pigments such as a phthalocyanine pigment such as phthalocyanine blue and phthalocyanine green, an azo pigment, a condensed azo pigment, an azo lake pigment, an anthraquinone pigment, an indigo pigment, a thioindigo pigment, an isoindolinone pigment, an azomethine azo pigment, an aniline black pigment, a triphenylmethane pigment, a perinone pigment, a perylene pigment, a quinophthalone pigment, a dioxazine pigment, and a quinacridone pigment such as quinacridone red.

Examples of the dyes include an azo dye, an anthraquinone dye, a quinone phthalone dye, a styryl dye, a diphenylmethane dye, a triphenylmethane dye, an oxazine dye, a triazine dye, a xanthan dye, an azomethine dye, an acridine dye, and a diazine dye.

The content of the colorant can be approximately 0.1 parts by mass or greater, approximately 0.5 parts by mass or more, or approximately I part by mass or greater, approximately 100 parts by mass or less, approximately 75 parts by mass or less, or approximately 50 parts by mass or less, based on 100 parts by mass of the total of the carboxy group-containing (meth)acrylic polymer and the amino group-containing (meth)acrylic polymer.

At least one of the carboxy group-containing (meth)acrylic polymer and the amino group-containing (meth)acrylic polymer may function as a dispersant of a colorant. In this embodiment, a colorant and a (meth)acrylic polymer functioning as a dispersant are mixed to prepare a premix (also referred to as a mill base), and the obtained premix is mixed with other components of the colored adhesive composition used to form the colored adhesive layer. As a result, a large amount of colorant can be stably dispersed in the colored adhesive layer. Furthermore, the premix is prepared for a plurality of colorants, and the color tone can be easily adjusted by appropriately mixing these premixes.

The carboxy group-containing (meth)acrylic polymer or the amino group-containing (meth)acrylic polymer functioning as the dispersant may be the same as or different from that functioning as the acrylic tacky polymer or the acrylic polymer additive. In the latter case, the colored adhesive layer contains two or more kinds of carboxy group-containing (meth)acrylic polymers or amino group-containing (meth)acrylic polymers, that is, a carboxy group-containing (meth)acrylic polymer or an amino group-containing (meth)acrylic polymer functioning as a dispersant, and a carboxy group-containing (meth)acrylic polymer or an amino group-containing (meth)acrylic polymer functioning as an acrylic tacky polymer or an acrylic polymer additive.

The weight average molecular weight (Mw) of the carboxy group-containing (meth)acrylic polymer or the amino group-containing (meth)acrylic polymer functioning as a dispersant can be generally approximately 1000 or greater, or approximately 10000 or greater, and approximately 1500000 or less, or approximately 800000 or less.

The colored adhesive layer can be formed on a biaxially stretched PET film layer or a liner by using a colored adhesive composition containing a carboxy group-containing (meth)acrylic polymer, an amino group-containing (meth)acrylic polymer, and a colorant, and if necessary, a crosslinking agent, a solvent, and/or other additives.

Before the preparation of the colored adhesive composition, a colorant and a carboxy group-containing (meth)acrylic polymer or an amino group-containing (meth)acrylic polymer that functions as a dispersant may be mixed to prepare a premix. The mixing can be performed using, for example, a paint shaker, a sand grinding mill, a ball mill, an attritor mill, or a three-roll mill. At the time of mixing, an aqueous solvent or an organic solvent may be added as necessary. A colored adhesive composition can be prepared by mixing the obtained premix with other components of the colored adhesive composition. When a plurality of the colorants are used, the premix may be prepared for each colorant, and the premix may be appropriately mixed to adjust the color, and then the premix mixture may be mixed with other components of the colored adhesive composition.

The mass ratio of the colorant to the dispersant can be approximately from 1 to 100:approximately from 5 to 1000, approximately from 1 to 100: approximately from 10 to 700, or approximately from 1 to 100: approximately from 10 to 500. The dispersant may be used in total during the preparation of the premix, some during the preparation of the premix, and the remainder during the preparation of the colored adhesive composition.

The crosslinking agent is not particularly limited as long as it can form crosslinks between polymer chains of the carboxy group-containing (meth)acrylic polymer or the amino group-containing (meth)acrylic polymer. For example, as the crosslinking agent of the carboxy group-containing (meth)acrylic polymer, an epoxy crosslinking agent, a bisamide crosslinking agent, an aziridine crosslinking agent, a carbodiimide crosslinking agent, an isocyanate crosslinking agent, and the like can be used.

Examples of the epoxy crosslinking agent include N,N,N′,N′-tetraglycidyl-1,3-benzene di(methanamine) (TETRAD-X (Mitsubishi Gas Chemical Company, Inc. (Chiyoda-ku, Tokyo, Japan), E-AX and E-5XM (both are available from Soken Chemical & Engineering Co., Ltd., Toshima-ku, Tokyo, Japan) and N,N′-(cyclohexane-1,3-diylbismethylene) bis(diglycidylamine) (TETRAD-C (Mitsubishi Gas Chemical Company, Inc. (Chiyoda-ku, Tokyo, Japan) and E-5C (Soken Chemical & Engineering Co., Ltd., Toshima-ku, Tokyo, Japan) as trade names).

Examples of the bisamide crosslinking agent include 1,1′-isophthaloyl-bis(2-methylaziridine), 1,4-bis(ethyleneiminocarbonylamino) benzene, 4,4′-bis(ethyleneiminocarbonylamino) diphenylmethane, and 1,8-bis(ethyleneiminocarbonylamino) octane.

Examples of the aziridine crosslinking agent include 2,2-bishydroxymethylbutanol-tris[3-(1-aziridinyl)propionate (trade name: CHEMITITE (trade name) PZ-33 (Nippon Shokubai Co., Ltd., Osaka-shi, Osaka, Japan)) and Crosslinker CX-100 (DSM Coating Resins B.V. (Zwolle, Nederland).

Examples of the carbodiimide crosslinking agent include Carbodilite V-03, V-05,and V-07 (which are available from Nisshinbo Holdings Inc. (Chuo-ku, Tokyo, Japan)).

Examples of the isocyanate crosslinking agent include CORONATE L and CORONATE HK (both are available from Tosoh Corporation (Minato-ku, Tokyo, Japan)).

The crosslinking agent can be used in an amount of approximately 0.01 parts by mass or greater, approximately 0.02 parts by mass or greater or approximately 0.05 parts by mass or greater, and approximately 0.5 parts by mass or less, approximately 0.4 parts by mass or less, or approximately 0.3 parts by mass or less, based on 100 parts by mass of the carboxy group-containing (meth)acrylic polymer or the amino group-containing (meth)acrylic polymer functioning as an acrylic tacky polymer.

Examples of the solvent include methanol, ethanol, hexane, heptane, toluene, acetone, methyl ethyl ketone, methyl isobutyl ketone, ethyl acetate, and butyl acetate, or mixed solvents thereof.

Examples of other additives include an ultraviolet absorber, an antioxidant, a heat stabilizer, a filler, and a tacky producer.

The thickness of the colored adhesive layer can vary, and can be, for example, approximately 5 μm or greater, approximately 10 μm or greater, or approximately 20 μm or greater, and approximately 200 μm or less, approximately 100 μm or less, or approximately 80 μm or less. From the viewpoint of the non-flammability of the decorative film, the thickness of the colored adhesive layer is preferably approximately 50 μm or less, and more preferably approximately 30 μm or less.

The decorative film can be produced by a known method. For example, the colored adhesive composition is applied onto a liner by knife coating, bar coating or the like and dried to form a colored adhesive layer. In order to react the optional crosslinking agent, the colored adhesive layer may be heated during drying using hot air, an oven, or the like. A biaxially stretched PET film layer can be stacked on the obtained colored adhesive layer by a method such as dry laminating to produce a decorative film. A decorative film can also be produced by directly applying the colored adhesive composition onto the biaxially stretched PET film layer and drying the colored adhesive composition.

The decorative film may have a liner on the surface of the colored adhesive layer opposite to the biaxially stretched PET film layer. Examples of the liner which is an optional component include a plastic material such as polyethylene, polypropylene, polyester, or cellulose acetate, paper, and laminate paper of the plastic material. These liners may have surfaces release-treated with silicone or the like. The thickness of the liner can be generally approximately 10 μm or greater or approximately 25 μm or greater, and approximately 500 μm or less or approximately 200 μm or less.

The colored adhesive layer may be solid, porous, or foam. The adhesive surface of the colored adhesive layer may be flat or may have irregularities. The uneven adhesive surface includes an adhesive surface in which a convex portion containing a solid content of the colored adhesive composition or a solid content of a reactant and a concave portion surrounding the convex portion are formed on the adhesive surface of the colored adhesive layer, and a communication path communicating with the outside defined by the concave portion is formed between the surface of the adherend and the adhesive surface in a state of being adhered to the adherend. An example of a method for forming the uneven adhesive surface will be described below.

A liner having a release surface having a predetermined uneven structure is prepared. The colored adhesive composition is applied to the release surface of the liner, and heated as necessary to form the colored adhesive layer. As a result, the uneven structure (negative structure) of the liner is transferred to the surface (which is the adhesive surface of the decorative film) of the colored adhesive layer in contact with the liner, and the uneven adhesive surface having a predetermined structure (positive structure) is formed on the adhesive surface. As described above, the unevenness of the adhesive surface is designed in advance to include a groove in which a communication path can be formed when the convex portion is bonded to the adherend.

The groove of the colored adhesive layer may form a groove of a regular pattern by arranging a groove of a regular shape along a regular pattern on the adhesive surface, or may form a groove of an irregular pattern by arranging a groove of an indefinite shape. When the plurality of grooves are formed so as to be arranged substantially parallel to each other, the arrangement interval of the grooves is preferably approximately 10 μm or greater or approximately 100 μm or greater, and approximately 2000 μm or less or approximately 1000 μm or less. A depth of the groove (distance from adhesive surface to bottom of groove measured in direction of biaxially stretched PET film layer) is usually approximately 10 μm or greater and approximately 100 μm or less. The shape of the groove is not particularly limited as long as the effect of the present invention is not impaired. For example, the shape of the groove may be substantially rectangular (including trapezoidal), substantially semicircular, or substantially semi-elliptical in a cross section of the groove in a direction perpendicular to the adhesive surface.

In one embodiment, the thickness of the decorative film excluding the liner is approximately 270 μm or less, approximately 200 μm or less, or approximately 100 μm or less. The thickness of the decorative film excluding the liner can be approximately 30 μm or greater, approximately 40 μm or greater, or approximately 50 μm or greater.

In one embodiment, the visible light transmittance of the decorative film excluding the liner is approximately 10% or greater, approximately 30% or greater, or approximately 50% or greater, and approximately 99% or less, approximately 97% or less, or approximately 95% or less.

A pencil hardness on the side of the biaxially stretched polyethylene terephthalate film layer of the decorative film is B or greater. The pencil hardness is preferably H or more, and more preferably 2H or greater.

The tensile strength at 2% elongation of the decorative film is approximately 50 N/25 mm or greater. The tensile strength at 2% elongation is preferably approximately 60 N/25 mm or greater, and more preferably approximately 75 N/25 mm or greater.

The elongation of the decorative film is approximately 60% or greater. The elongation is preferably approximately 70% or greater, and more preferably approximately 80% or greater.

The pencil hardness, tensile strength at 2% elongation, and elongation are determined by the procedure described in examples.

The decorative film has a total calorific value of 8 MJ/m² or less for 20 minutes after the start of heating as measured in accordance with the ISO 5660-1 cone calorie meter heat resistance test. In one embodiment, the total calorific value is approximately 7 MJ/m² or less, or 6 MJ/m² or less. When the total calorific value is 8 MJ/m² or less, the decorative film is determined to be non-flammable.

The anti-scatter film is preferably transparent. Transparent means that the total light transmittance in the wavelength range from 380 to 780 nm is approximately 80% or greater.

In one embodiment, the decorative film is substantially free of a flame retardant. Here, “substantially free” means that the content of the flame retardant is less than approximately 1 mass %, less than approximately 0.5 mass %, or less than approximately 0.2 mass %, based on the mass of the decorative film. Examples of the flame retardant include organic flame retardants such as a bromine flame retardant, a phosphorus flame retardant, and a chlorine flame retardant, and inorganic flame retardants such as an antimony compound, a metal hydroxide, a nitrogen compound, and a boron compound. Adhesiveness of the decorative film may be lowered by adding the flame retardant, and therefore, the adhesiveness of the decorative film can be secured by not containing the flame retardant. In addition, the addition of the flame retardants may reduce the elongation characteristics of the decorative film.

The decorative film of the present disclosure can be suitably used for an interior of a vehicle as a decorative film for a vehicle interior, and can be suitably used for a window glass of a vehicle, a building, or the like as an anti-scatter film.

### EXAMPLES

Specific embodiments of the present disclosure will be exemplified in the following examples, but the present invention is not limited to these embodiments. All parts and percentages are by mass unless otherwise stated.

The materials used for preparing the decorative film are shown in Table 1.

TABLE 1

| | Composition or description¹⁾ | Supplier |
|---|---|---|
| PET film 1 | TOYOBOESTER | TOYOBO FILM |
| (FL1) | (trade name) film | SOLUTIONS |
| | HB3, biaxially | LIMITED |
| | stretched PET film, | (Chuo-ku, |
| | thickness: 50 μm | Tokyo, Japan) |
| PET film 2 | TOYOBOESTER | TOYOBO FILM |
| (FL2) | (trade name) film | SOLUTIONS |
| | G2, biaxially | LIMITED |
| | stretched PET film, | (Chuo-ku, |
| | thickness: 50 μm | Tokyo, Japan) |
| PET film 3 | UVA-filled biaxially | 3M Japan Limited |
| (FL3) | stretched PET | (Shinagawa-ku, |
| | film with hard coat | Tokyo, |
| | layer, thickness: | Japan) |
| | 30 pm | |
| PET film 4 | COSMOSHINE | Toyobo Co., Ltd. |
| (FL4) | (trade name) A4160, | (Osaka-shi, Osaka, |
| | high-transparency | |
| | biaxially stretched | |
| | PET film, thickness: 100 μm | Japan) |
| PET film 5 | COSMOSHINE | Toyobo Co., Ltd. |
| (FL5) | (trade name) A4160, | (Osaka-shi, Osaka, |
| | high-transparency | Japan) |
| | biaxially stretched | |
| | PET film, thickness: 188 μm | |
| (meth)acrylic | MMA-BMA-DMAEMA = | — |
| polymer 1 | 60:34:6, Tg = 63° C., weight | |
| (AP1) | average molecular | |
| | weight (Mw) 68000, | |
| | 40 mass % Et0 | |
| | Ac solution | |
| (meth)acrylic | BA-2EHA-Vac-AA-ACM = | — |
| polymer 2 | 40:47:8:5:0.1, Tg = 51° C., | |
| (AP2) | weight average | |
| | molecular weight | |
| | (Mw) 550000, 40 | |
| | mass % toluene/Et0 | |
| | Ac solution | |
| Tacky | BA-2EHA-AN-AA = 58:36:2:4, | — |
| polymer 1 | Tg = −53° C., weight | |
| (ADH1) | average molecular | |
| | weight (Mw) 550000, | |
| | 33 mass % Et0 | |
| | Ac solution | |
| Tacky | BA-AA = 96:4, Tg = | — |
| polymer 2 | −50° C., weight | |
| (ADH2) | average molecular | |
| | weight (Mw) 580000, | |
| | 42 mass % toluene/Et0Ac | |
| | solution | |
| Crosslinking | Bisamide crosslinking | 3M Japan Limited |
| agent | agent, 1,1′- | (Shinagawa-ku, |
| 1 (CL1) | isophthaloylbis(2- | Tokyo, |
| | methylaziridine), 5 | Japan) |
| | mass % toluene solution | |
| Crosslinking | Tetrad-X, polyfunctional | Mitsubishi |
| agent | liquid epoxy | Gas Chemical |
| 2 (CL2) | resin, N,N′,-tetraglycidyl-m- | Company, Inc. |
| | xylenediamine | (Chiyoda-ku, Tokyo, |
| | | Japan) |

¹⁾MMA: methyl methacrylate, BMA: n-butyl methacrylate, DAMEME: dimethylaminoethyl methacrylate
BA: n-butyl acrylate,
2EHA: 2-ethylhexyl acrylate,
Vac: vinyl acetate
AA: acrylic acid,
ACM: acrylamide,
AN: acrylonitrile,
Et0Ac: ethyl acetate

The pigments 1 to 4 used for preparing the decorative film are shown in Table 2.

TABLE 2

| | Color | C.I. | Description | Supplier |
|---|---|---|---|---|
| Pigment 1 | White | — | TiPure (trade name) | The Chemours |
| (PG1) | | | R960, titanium | Company |
| | | | dioxide | (Wilmington, |
| | | | (TiO₂) | DE, USA) |
| Pigment 2 | Orange | Pigment | CROMOPHTAL (trade | BASF (Basel, |
| (PG2) | | Orange 61 | name) ORANGE 2G | Switzerland) |
| Pigment 3 | Yellow | Pigment | IRGAZIN (trade name) | BASF (Basel, |
| (PG3) | | Yellow | YELLOW 2 GLTE | Switzerland) |
| | | 154 | | |
| Pigment 4 | Yellow | Pigment | Raven (trade name) | Columbia |
| (PG4) | | Black 7 | Carbon Black 1200 | Chemicals |
| | | | | Company |
| | | | | (Marietta, |
| | | | | GA, USA) |

The formulations of mill bases 1 to 4 (premix) used for preparing the decorative film are shown in Table 3.

TABLE 3

| | | | Resin | |
|---|---|---|---|---|
| | Pigment | | | mass % |
| | Type | mass % | Type | (solid content) |
| Mill Base 1 (MB1) | PG1 | 55 | AP1 | 11 |
| Mill Base 2 (MB2) | PG2 | 10 | AP2 | 16 |
| Mill Base 3 (MB3) | PG3 | 10 | AP2 | 16 |
| Mill Base 4 (MB4) | PG4 | 5 | AP2 | 20 |

The formulations of the colored adhesive compositions CA1 to CA3 and CA6 used for preparing the decorative film are shown in Table 4.

TABLE 4
(Numerical value is wet mass %)

| | Colored adhesive solution | | | |
|---|---|---|---|---|
| | CA1 | CA2 | CA3 | CA6 |
| MB1 | 15 | 6 | 5 | 23 |
| MB2 | 6 | 11 | 11 | — |
| MB3 | 8 | 11 | 4 | 1 |
| MB4 | 1 | 1 | 3 | 1 |
| ADH2 | 70 | 69 | 75 | 75 |
| AP1 | — | 2 | 2 | — |

### Example 1

A crosslinking agent 1 (CL1) was mixed with a colored adhesive composition CA1. The mass ratio of a tacky polymer 2 (ADH2) to CL1 in CA1 was 100:0.05 on a non-volatile basis. The obtained colored adhesive composition was applied onto a liner having a structured surface (SCW 860 DNL, 3M Japan Limited, Minato-ku, Tokyo, Japan) using a knife coater, and dried at 95° C. for 3 minutes. A colored adhesive layer having a thickness of 25 μm was obtained after drying. The colored adhesive layer was bonded to a film 1 (FL1) to obtain a decorative film of Example 1.

### Examples 2 and 3

Except that the colored adhesive composition was changed as shown in Table 5, the same procedure as in Example 1 was carried out to obtain a decorative film.

### Example 4

A white pigment premix containing a pigment 1 (PG1) as a white pigment, a (meth)acrylic polymer 1 (AP1), and methyl ethyl ketone (MEK) was prepared. The mass ratio of PG1 to API was 5:1 on the non-volatile basis. The solid content of the white pigment premix was approximately 66 mass %. A colored adhesive composition CA4 containing a white pigment premix and a tacky polymer 1 (ADH1) was prepared. The mass ratio of ADH1, PG1, and AP1 was 100:50: 10 on the non-volatile basis. CL1 was mixed with CA4 to obtain a white adhesive composition. The mass ratio of ADH1 to CL1 is 100:0.2 on the non-volatile basis. The solid content of the white adhesive composition was approximately 35 mass %.

The white adhesive composition was applied onto a silicone-coated polyethylene laminate paper liner using a knife coater and dried at 95° C. for 5 minutes. A white adhesive layer having a thickness of 30 μm was obtained after drying. The white adhesive layer and FL1 were bonded to obtain a decorative film of Example 4.

### Example 5

A white pigment premix was prepared by the same procedure as in Example 4.Thereafter, a colored adhesive composition CA5 containing a white pigment premix and ADH2 was prepared. The mass ratio of ADH2, PG1, and API was 100:40:8 on the non-volatile basis. CL2 was mixed with CA5 to obtain a white adhesive composition. The mass ratio of ADH2 to CL2 was 100:0.05 on the non-volatile basis. The solid content of the white adhesive composition was approximately 38 mass %.

The white adhesive composition was applied onto a silicone-coated polyethylene laminate paper liner using a knife coater and dried at 95° C. for 5 minutes. A white adhesive layer having a thickness of 40 μm was obtained after drying. The white adhesive layer and FL1 were bonded to obtain a decorative film of Example 5.

### Example 6

CL1 was mixed into a colored adhesive composition CA6. The mass ratio of ADH1 to CL1 in CA6 is 100:0.2 on the non-volatile basis. The obtained colored adhesive composition was applied onto a silicone-coated polyethylene laminate paper liner using a knife coater and dried at 95° C. for 3 minutes. A colored adhesive layer having a thickness of 21 μm was obtained after drying. The colored adhesive layer and FL2 were bonded to obtain a decorative film of Example 6.

### Example 7

Except that FL2 was changed to FL3, the same procedure as in Example 6 was carried out to obtain a decorative film.

### Comparative Example 1

As a decorative film of Comparative Example 1, 3M (trade name) Scotchtint (registered trademark) window film SH2CLAR-R5 (3M Japan Limited, Minato-ku, Tokyo, Japan) was used.

### Comparative Example 2

As a decorative film of Comparative Example 2, 3M (trade name) Scotchcal (trade name) paint film PF 121 AP (3M Japan Limited, Minato-ku, Tokyo, Japan) was used.

### Example 8

Except that FL1 was changed to FL4, the same procedure as in Example 3 was carried out to obtain a decorative film.

### Example 9

Except that FL1 was changed to FL5, the same procedure as in Example 3 was carried out to obtain a decorative film.

### Example 10

Except that the thickness of the white adhesive layer after drying was changed 80 μm, the same procedure as in Example 5 was carried out to obtain a decorative film. The decorative film was evaluated for the following items.

### Tensile Strength at 1.2% Elongation

The decorative film was cut into a width of 25 mm×a length of 150 mm to prepare a test piece. Using a tensile tester (Tensilon (trade name) universal testing machine, model number: RTC-1210 A, A&D Company, Limited, Toshima-ku, Tokyo, Japan), the stress at 2% elongation at a temperature of 20° C. was recorded as 2% tensile strength. The tensile speed was 300 mm/min, and a chuck interval was 100 mm.

### 2. Tensile Strength at Yield

The decorative film was cut into a width of 25 mm×a length of 150 mm to prepare a test piece. Using a tensile tester (Tensilon (trade name) universal testing machine, model number: RTC-1210 A, A&D Company, Limited, Toshima-ku, Tokyo, Japan), the stress at a yield point at a temperature of 20° C. was recorded as a tensile strength at yield. The tensile speed was 300 mm/min, and a chuck interval was 100 mm.

### 3. Strength and Elongation at Break

The decorative film was cut into a width of 25 mm×a length of 150 mm to prepare a test piece. Using a tensile tester (Tensilon (trade name) universal testing machine, model number: RTC-1210A, A&D Company, Limited, Toshima-ku, Tokyo, Japan), the strength and elongation when the test piece was broken (=(length of test piece at break-length of test piece before test)/length of test piece before test) were recorded as the strength and elongation at break, respectively. The tensile speed was 300 mm/min, and a chuck interval was 100 mm.

### 4. Adhesive Force

The decorative film was cut into a width of 25 mm×a length of 150 mm to prepare a test piece. The test piece was bonded onto a melamine-coated plate (PALTEK Corporation, Hiratsuka-shi, Kanagawa, Japan), an A5052P aluminum panel, an SUS304BA panel (PALTEK Corporation, Hiratsuka-shi, Kanagawa, Japan), or a float-glass panel (AGC Inc., Chiyoda-ku, Tokyo, Japan) having a thickness of 3 mm at 20° C. The bonding method was in accordance with JIS Z 0237:2009 8.2.3. The test piece was left at 20° C. for 48 hours. Using a tensile tester (Tensilon (trade name) universal testing machine, model number: RTC-1210 A, A&D Company, Limited, Toshima-ku, Tokyo, Japan), the adhesive force (N/25 mm) when 180° peeling was performed at a temperature of 20° C. and a peeling rate of 300 mm/min was measured.

### 5. Thermal Shrinkage

The decorative film was cut into a width of 50 mm×a length of 100 mm to prepare a test piece. The test piece was bonded onto an A5052P aluminum panel with a roller in an environment of 23° C., and left to stand in an environment of 23° C. for 24 hours.

A cross cut was made in the test piece with a cutter. Thereafter, the test piece was heated at 65° C. for 48 hours. After heating and aging, the shrinkage amount (mm) of the film was measured with a microscope, and the maximum value was recorded.

### 6. Pencil Hardness (Scratch Resistance)

A test was performed in accordance with JIS K 5600 May 4 (ISO/DIN 15184). The hardness of the hardest pencil that did not produce a scar is defined as the scratch hardness. A case of 4H or more was evaluated as “A”, a case of B to 3H was evaluated as “B”, and a case of 2B or less was evaluated as “C”. A and B were determined to be acceptable.

### 7. Non-Flammability Test

A decorative film was bonded to a galvanized steel sheet (thickness: 0.27 mm). A test was carried out in accordance with ISO 5660-1 cone calorie meter heat resistance test. As parameters, the heat generation rate (kW/m²) and the total calorific value (MJ/m²) were measured using a cone calorimeter (available from Toyo Seiki Seisaku-sho, Ltd.). A case where the total calorific value during 20 minutes after the start of heating was 8 MJ/m² or less and the time during which the heat generation rate exceeded 200 kW/m² was 10 seconds or less in total was determined as acceptable, and other cases were determined as unacceptable.

The configurations and evaluation results of the decorative films of Examples 1 to 10 and Comparative Examples 1 and 2 are shown in Tables 5 and 6. respectively.

TABLE 5

| | | | | Crosslinking | | Adhesive | | |
|---|---|---|---|---|---|---|---|---|
| | Film | | Colored | agent | | layer | | Total |
| | | Thickness | adhesive | | Part by | Thickness | | thickness |
| | Type | [μm] | solution | Type | mass | [μm] | Coloring | [μm] |
| Example 1 | FL1 | 50 | CA1 | CL1 | 0.05 | 25 | Presence | 75 |
| Example 2 | FL1 | 50 | CA2 | CL1 | 0.05 | 25 | Presence | 75 |
| Example 3 | FL1 | 50 | CA3 | CL1 | 0.05 | 25 | Presence | 75 |
| Example 4 | FL1 | 50 | CA4 | CL1 | 0.20 | 30 | Presence | 80 |
| Example 5 | FL1 | 50 | CA5 | CL2 | 0.05 | 40 | Presence | 90 |
| Example 6 | FL2 | 50 | CA6 | CL1 | 0.20 | 21 | Presence | 71 |
| Example 7 | FL3 | 30 | CA6 | CL1 | 0.20 | 21 | Presence | 51 |
| Comparative | — | — | — | — | — | — | None | 78 |
| Example 1 | | | | | | | | |
| Comparative | — | — | — | — | — | — | Presence | 83 |
| Example 2 | | | | | | | | |
| Example 8 | FL4 | 100 | CA3 | CL1 | 0.05 | 25 | Presence | 125 |
| Example 9 | FL5 | 188 | CA3 | CL1 | 0.05 | 25 | Presence | 213 |
| Example 10 | FL1 | 50 | CA5 | CL2 | 0.05 | 80 | Presence | 130 |

TABLE 6

| | Tensile | | | | | | | | | | | |
|---|---|---|---|---|---|---|---|---|---|---|---|---|
| | strength | Tensile | | | Adhesive force | | | | | | | |
| | at 2% | strength | Strength | | [N/25 mm] | | | | | | | |
| | elongation | at yield | at break | | Melamine- | | | | Thermal | | | |
| | [N/25 | [N/25 | [N/25 | Elongation | coated | | | | shrinkage | Pencil hardness | | Non- |
| | mm] | mm] | mm] | [%] | plate | AI | SUS | Glass | [mm] | Results | Determination | flammability |
| Example 1 | 89 | 152 | 276 | 122 | 5 | 12 | 1 | 11 | 0.08 | 4H | A | N.D. |
| Example 2 | 87 | 153 | 272 | 123 | 7 | 10 | 2 | 11 | 0.12 | N.D. | N.D. | N.D. |
| Example 3 | 91 | 155 | 154 | 105 | 7 | 13 | 2 | 11 | 0.14 | 2H | B | Acceptable |
| Example 4 | 83 | 250 | 317 | 114 | 5 | 13 | 1 | 11 | 0.12 | N.D. | N.D. | N.D. |
| Example 5 | 82 | 198 | 204 | 115 | 10 | 21 | 5 | 16 | 0.10 | H | B | Acceptable |
| Example 6 | 76 | 155 | 260 | 164 | 2 | 5 | 0 | 7 | 0.08 | N.D. | N.D. | N.D. |
| Example 7 | 41 | 137 | 155 | 88 | 3 | 5 | 2 | 5 | N.D. | H | B | Acceptable |
| Comparative | 66 | 152 | 201 | 121 | 6 | 5 | 1 | 9 | 0.11 | 8H | A | Acceptable |
| Example 1 | | | | | | | | | | | | |
| Comparative | 4 | 9 | 10 | 174 | 18 | 23 | 13 | 25 | 0.10 | <6B | C | Acceptable |
| Example 2 | | | | | | | | | | | | |
| Example 8 | N.D. | N.D. | N.D. | N.D. | 7 | 14 | 23 | 9 | 0.12 | 5H | A | Acceptable |
| Example 9 | N.D. | N.D. | N.D. | N.D. | 5 | 7 | 5 | 4 | 0.12 | 4H | A | Acceptable |
| Example 10 | N.D. | N.D. | N.D. | N.D. | 14 | 19 | 19 | 18 | 0.12 | HB | B | Acceptable |

(N.D. means not measured)

FIG. 2 is a graph showing a relationship between an elongation (%, lateral axis) and a tensile strength (N/25 mm, vertical axis) of the decorative film of Example 1 and Comparative Example 1.

It is apparent to those skilled in the art that various modifications can be made to the above embodiments and examples without departing from the basic principle of the present invention. In addition, it is apparent to those skilled in the art that various modifications and variations of the present invention can be implemented without departing from the spirit and scope of the present invention.

### REFERENCE SIGNS LIST

10 Decorative film (decorative film for a vehicle interior and anti-scatter film)
12 Biaxially stretched polyethylene terephthalate film layer
14 Colored adhesive layer
16 Liner

1. A decorative film for a vehicle interior comprising:
a biaxially stretched polyethylene terephthalate film layer; and
a colored adhesive layer, wherein
the colored adhesive layer contains a carboxy group-containing (meth)acrylic polymer, an amino group-containing (meth)acrylic polymer, and a colorant,
a pencil hardness on a side of the biaxially stretched polyethylene terephthalate film layer of the decorative film is B or greater,
a tensile strength at 2% elongation of the decorative film is 50 N/25 mm or greater,
an elongation of the decorative film is 60% or greater, and
a total calorific value for 20 minutes after the start of heating measured in accordance with an ISO 5660-1 cone calorie meter heat resistance test is 8 MJ/m² or less.

2. The decorative film for a vehicle interior according to claim 1,
wherein the biaxially stretched polyethylene terephthalate film layer contains an ultraviolet absorber.

3. The decorative film for a vehicle interior according to claim 1,
wherein the decorative film is substantially free of a flame retardant.

4. The decorative film for a vehicle interior according to claim 1,
wherein the decorative film consists of the biaxially stretched polyethylene terephthalate film layer and the colored adhesive layer.

5. The decorative film for a vehicle interior according to claim 1,
wherein a total light transmittance of the biaxially stretched polyethylene terephthalate film layer in a wavelength range from 380 to 780 nm is 80% or greater.

6. The decorative film for a vehicle interior according to claim 1,
wherein a thickness of the decorative film for a vehicle interior is 270 μm or less.

7. An anti-scatter film comprising:
a biaxially stretched polyethylene terephthalate film layer; and
a colored adhesive layer, wherein
the colored adhesive layer contains a carboxy group-containing (meth)acrylic polymer, an amino group-containing (meth)acrylic polymer, and a colorant,
a pencil hardness on a side of the biaxially stretched polyethylene terephthalate film layer of the anti-scatter film is B or greater,
a tensile strength at 2% elongation of the anti-scatter film is 50 N/25 mm or greater,
an elongation of the anti-scatter film is 60% or greater, and
a total calorific value for 20 minutes after the start of heating measured in accordance with an ISO 5660-1 cone calorie meter heat resistance test is 8 MJ/m² or less.

8. The anti-scatter film according to claim 7,
wherein the biaxially stretched polyethylene terephthalate film layer contains an ultraviolet absorber.

9. The anti-scatter film according to claim 7,
wherein the anti-scatter film is substantially free of a flame retardant.

10. The anti-scatter film according to claim 7,
wherein the anti-scatter film consists of the biaxially stretched polyethylene terephthalate film layer and the colored adhesive layer.

11. The anti-scatter film according to claim 7,
wherein a total light transmittance of the biaxially stretched polyethylene terephthalate film layer in a wavelength range from 380 to 780 nm is 80% or greater.

12. The anti-scatter film according to claim 7,
wherein a thickness of the anti-scatter film is 270 μm or less.
